(19) United States
(12) Patent Application Publication
(10) Pub. No.: US 2010/0253029 A1
(43) Pub. Date: Oct. 7, 2010

(54) Round Baler Having Suspension Axle System

(75) Inventor: Cedric J. Blough, Moundridge, KS (US)

Correspondence Address: Hovey Williams LLP, 10801 Mastin Blvd., Suite 1000, Overland Park, KS, 66210, US

(73) Assignee: AGCO Corporation, Duluth, GA (US)

(21) Appl. No.: 12/419,841

(22) Filed: Apr. 7, 2009

(51) Int. Cl. B60G 9/02

(52) U.S. Cl. 280/124.116

(57) ABSTRACT

The ground wheels of a round baler are mounted on the chassis of the baler using a suspension system wherein a rigid axle of the system is spaced forwardly in offset relationship to spindles that journal the wheels for rotation. Fore-and-aft arms that connect the wheels with the axle are pivotally coupled with the axle in an independent manner so that each wheel can swing up and down relative to the chassis independently of the other wheel. Resilient cushion structure associated with the axle yieldably resists upward swinging of the wheel arms to thereby cushion the baler against jarring shock loads caused by abrupt terrain changes.

### TECHNICAL FIELD

The present invention relates to round balers and, more particularly, to a way of providing a suspension system for such balers so as to cushion the machines against shock loads encountered during field operations and travel along roadways.

### BACKGROUND AND SUMMARY

Conventional round balers are typically provided with fixed, transverse axles that pass below the baling chamber and bolt solidly to the chassis. Thus, as the baler is being towed in the field or along the road, it is subject to jarring impact loads as the ground wheels encounter abrupt changes in the terrain. This can be damaging to the equipment and physically demanding on the operator.

It would be desirable to provide a suspension system between the chassis and axle such that the wheel and axle assembly is essentially spring-loaded to cushion the baler against abrupt terrain changes. However, there are space and dimensional challenges to simply spring-loading the axle assembly that have heretofore not been overcome. For example, one challenge resides in the fact that the suspension system must not impede ejection of the finished bale from the baling chamber when the tailgate is raised and the bale falls out of the chamber by gravity.

Accordingly, an important object of the present invention is to provide an axle suspension system on a round baler that provides the desired cushioning support for the chassis and other portions of the baler without impeding ejection of a bale from the chamber when the tailgate is raised at the end of a baling cycle. It is also important and desirable to achieve a satisfactory suspension system that permits the ground wheels to remain rearward of the center of gravity of the baler when the bale is full-size, e.g., rearward of the center of the full-size baling chamber so as to optimize load distribution.

In achieving these objectives, the present invention contemplates an arrangement in which the load-supporting ground wheels are rotatable about axes of rotation disposed rearwardly of the fore-and-aft center of the baling chamber. However, instead of having a suspended axle that defines those axes of rotation, and which would interfere with the bale as it ejects from the baler, the present invention contemplates having a rigid, transverse axle that is spaced or offset forwardly from the axes of rotation of the wheels while permitting the wheels to have cushioned up and down swinging movement relative to the fixed axle. Offsetting the axle from the wheel rotation axes in this way clears space between the wheels for the ejecting bale to fall to the ground.

The two wheels are rotatably supported on relatively short spindles that are, in turn, supported by forwardly extending wheel arms pivotally coupled at their front ends with the rigid axle. The axle is tubular and rotatably receives shafts fixed to the front ends of the wheel arms such that the shafts rotate within the axle as the wheel arms and wheels swing up and down. Resilient cushions strategically located within the axle engage the shafts so as to yieldably resist rotation of the shafts in a direction corresponding to upward swinging of the wheel arms and the wheels. Each wheel is mounted independently of the other so as to provide independent suspension of the two wheels.

### BRIEF DESCRIPTION OF THE DRAWINGS

FIG. 1 is a left, rear isometric view of a baler employing a suspension axle system in accordance with the principles of the present invention, the left ground wheel being shown in phantom and portions of the kicker assembly (it moves the ejected bale rearwardly to provide clearance for reclosing the tailgate) being broken away to reveal details of construction;

FIG. 2 is an enlarged, fragmentary isometric view of the baler of FIG. 1 illustrating details of construction;

FIG. 3 is a longitudinal, vertical cross sectional view through the baler illustrating a full size bale in the baling chamber prior to ejection;

FIG. 4 is an enlarged, fragmentary cross sectional view similar to FIG. 3 but on a larger scale to reveal details of construction of the suspension axle system;

FIG. 5 is a vertical cross sectional view through the baler similar to FIG. 3 but illustrating the tailgate raised and the finished bale sitting on the ground immediately following ejection;

FIG. 6 is an exploded isometric view of one embodiment of a suspension axle system in accordance with the present invention;

FIG. 7 is an enlarged, schematic cross-sectional view of one end of the suspension axle taken substantially along line 7-7 of FIG. 6, the system being illustrated in an essentially no-load position wherein the wheels are essentially fully lowered relative to the axle;

FIG. 8 is a cross-sectional view of the suspension axle similar to FIG. 7 but illustrating the wheel arm in a nominal position under partial loading;

FIG. 9 is a cross-sectional view of the suspension axle similar to FIGS. 7 and 8 but illustrating the wheel arm in the highest (extreme shock) position;

FIG. 10 is a fragmentary cross-sectional view of a prior art baler having a fixed, forwardly offset axle; and

FIG. 11 is a fragmentary left rear isometric view of the prior art baler of FIG. 10.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

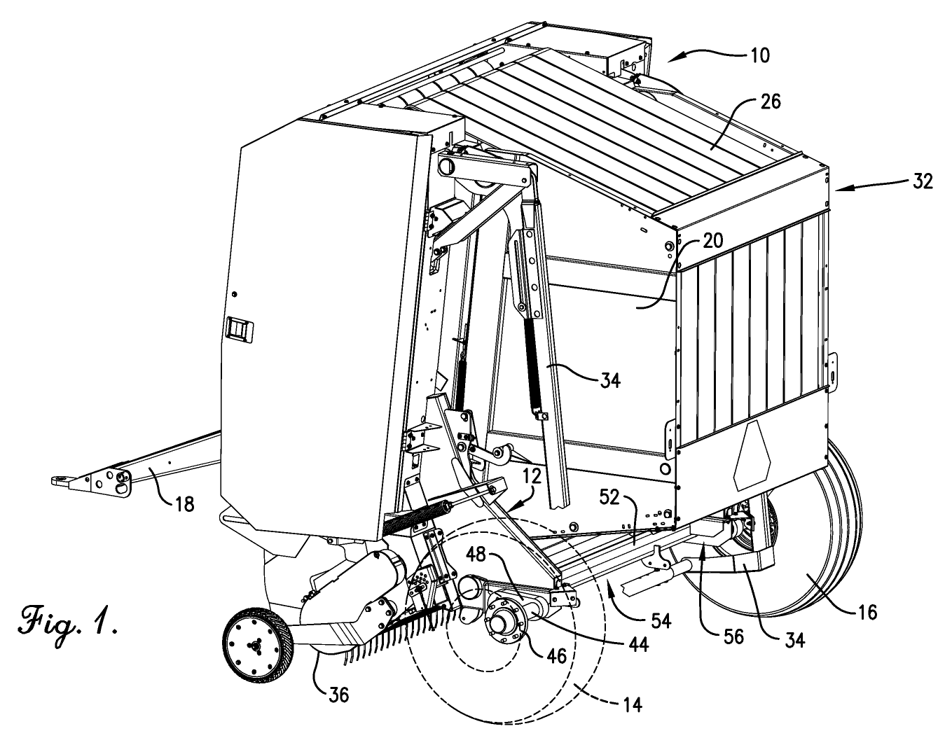

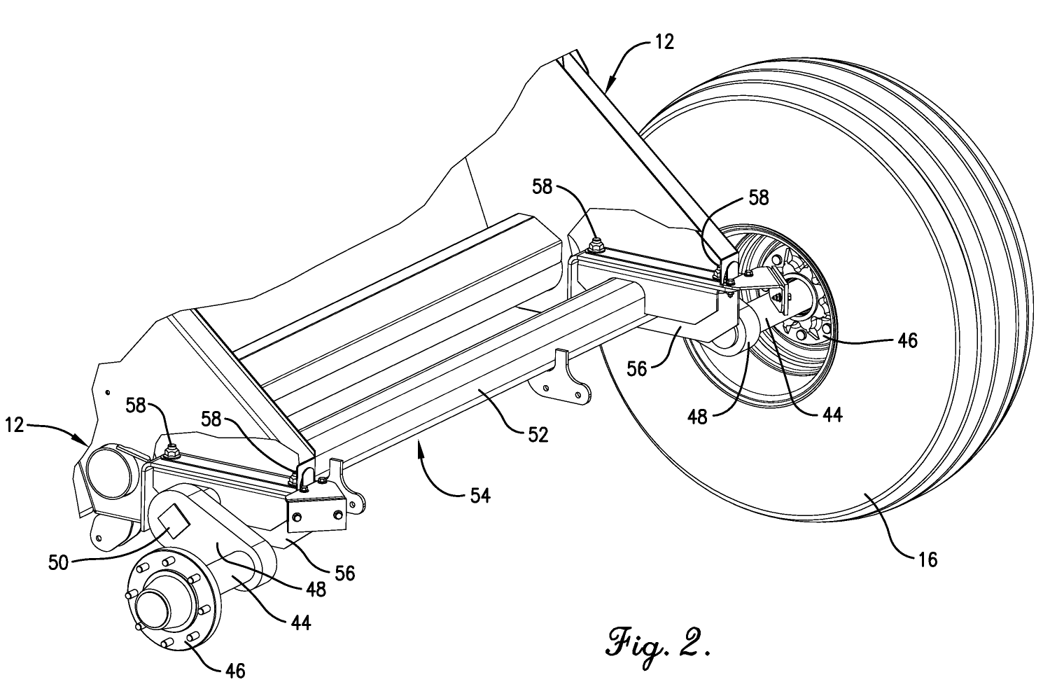

The baler 10 of FIGS. 1-9 has a chassis broadly denoted by the numeral 12 that is supported by a pair of left and right ground wheels 14, 16 for travel across the field and along roads and highways. A tongue 18 projecting forwardly from chassis 12 adapts baler 10 for connection to a towing tractor (not shown).

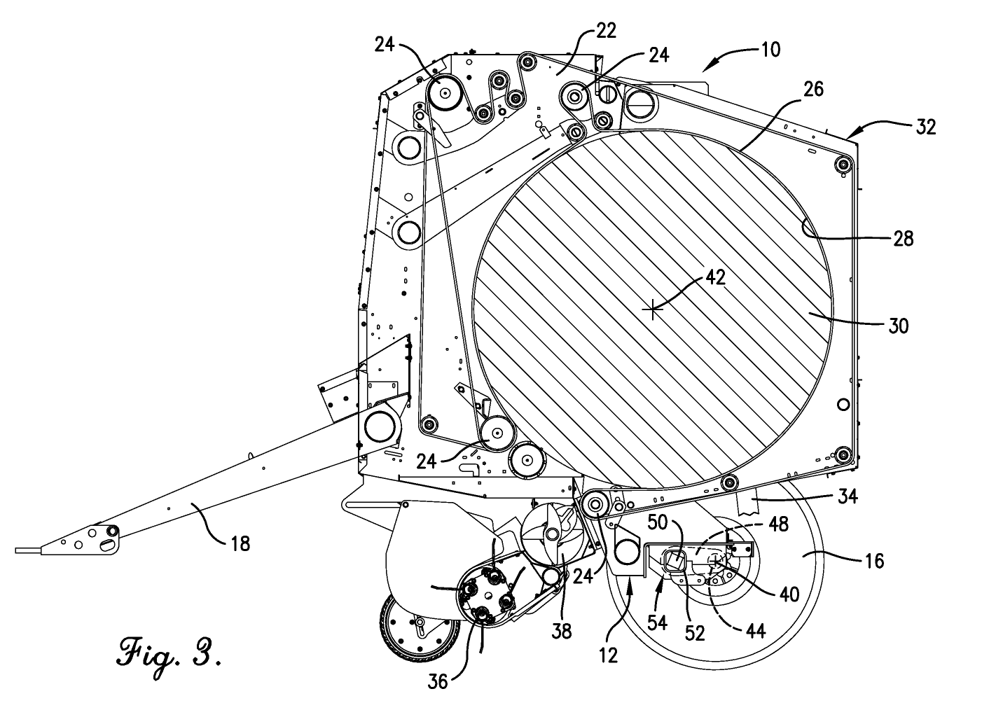

As well understood by those skilled in the art, baler 10 includes a pair of opposite side panels 20 and 22 that cooperate with a multiplicity of transversely extending rollers 24 and belts 26 to define an internal baling chamber 28. In the illustrated embodiment, baling chamber 28 is a variable-size chamber wherein the chamber is relatively small at the beginning of a baling cycle and then progressively enlarges as the cycle continues until reaching a full size condition as illustrated in FIG. 3 wherein a full size bale 30 is disposed therein. Belts 28 are maintained under tension during the baling cycle and are driven in such a direction that bale 30 rotates in a counterclockwise direction viewing FIG. 3 during the cycle, thus causing the bale to be compacted as it turns and as additional crop material is introduced into chamber 28 throughout the cycle. The particular structure used to define chamber 28 is of no consequence insofar as the principles of the present invention are concerned, and chamber 28 could be a fixed-size chamber without departing from the principles of the present invention.

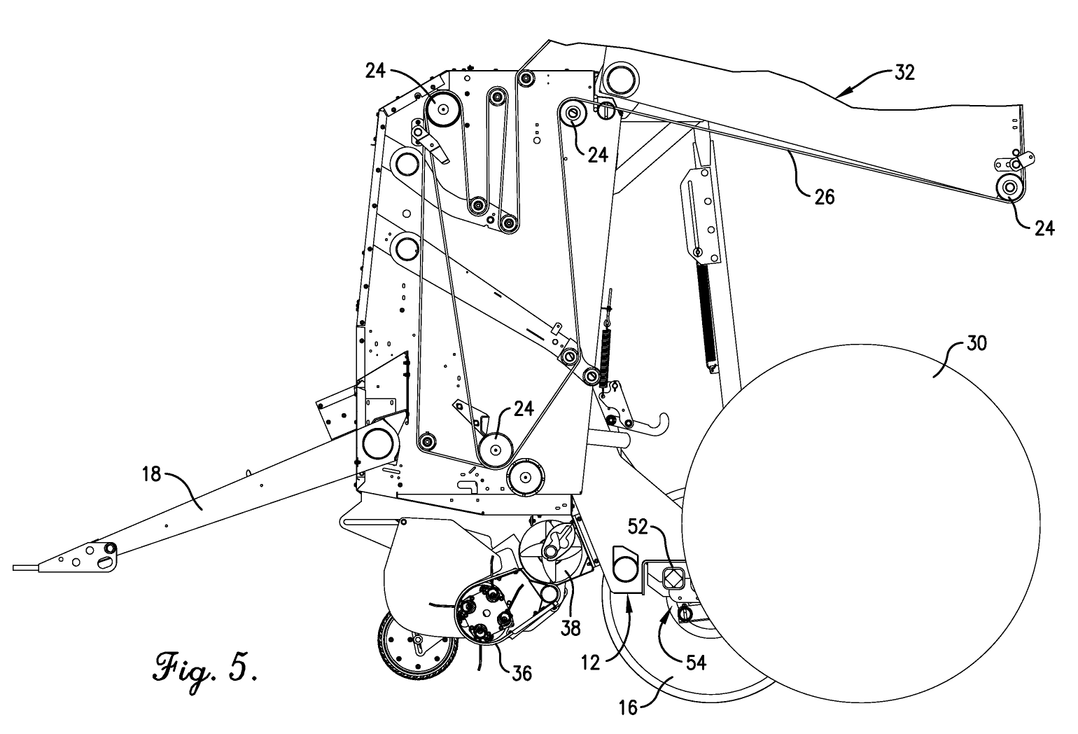

Rear portions of the side panels 20, 22 and belts 26 define a tailgate 32 that may be raised as illustrated in FIG. 5 to open chamber 28 at the completion of a baling cycle for the purpose of ejecting the bale 30 therefrom. With tailgate 32 raised, there is nothing to retain the bale within chamber 28, and the bale simply drops out of the opened chamber onto the ground, whereupon a conventional kicker 34 may be actuated to engage bale 30 and move it rearwardly a sufficient extent to permit tailgate 32 to be closed.

At the front of baler 10 generally below chamber 28 is disposed a pickup 36 that may be of conventional construction for the purpose of picking up the material from the ground as baler 10 is advanced and delivering such materials into the lower front portion of baling chamber 28. A variety of such pickups 36 and associated mechanisms, such as a center-gathering auger 38, may be utilized without departing from the principles of the present invention.

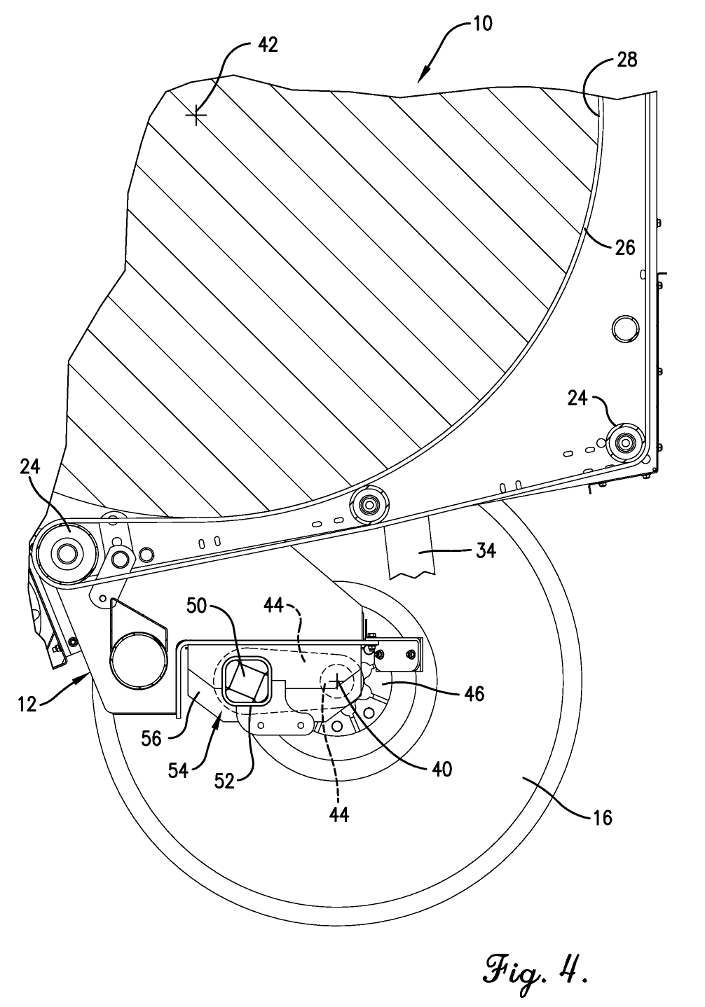

The axes of rotation of the two wheels 14, 16 are disposed in mutual axial alignment. As illustrated best in FIGS. 3 and 4, such axes are denoted by the numeral 40 and are disposed rearwardly of the fore-and-aft center 42 of baling chamber 28 when chamber 28 is full-size. Thus, the center of gravity of bale 30 when full-size, which corresponds to baling chamber center 42, is likewise disposed forwardly of the axes 40 of wheels 14, 16. This provides significant load distribution benefits but also presents a problem during unloading of the finished bale if the wheel axes 40 are defined by a cross axle having its longitudinal axis coinciding with the axes 40. Such an arrangement would most likely cause a bale ejecting from chamber 28 when tailgate 32 is raised to be caught by the axle and chassis instead of falling completely to the ground.

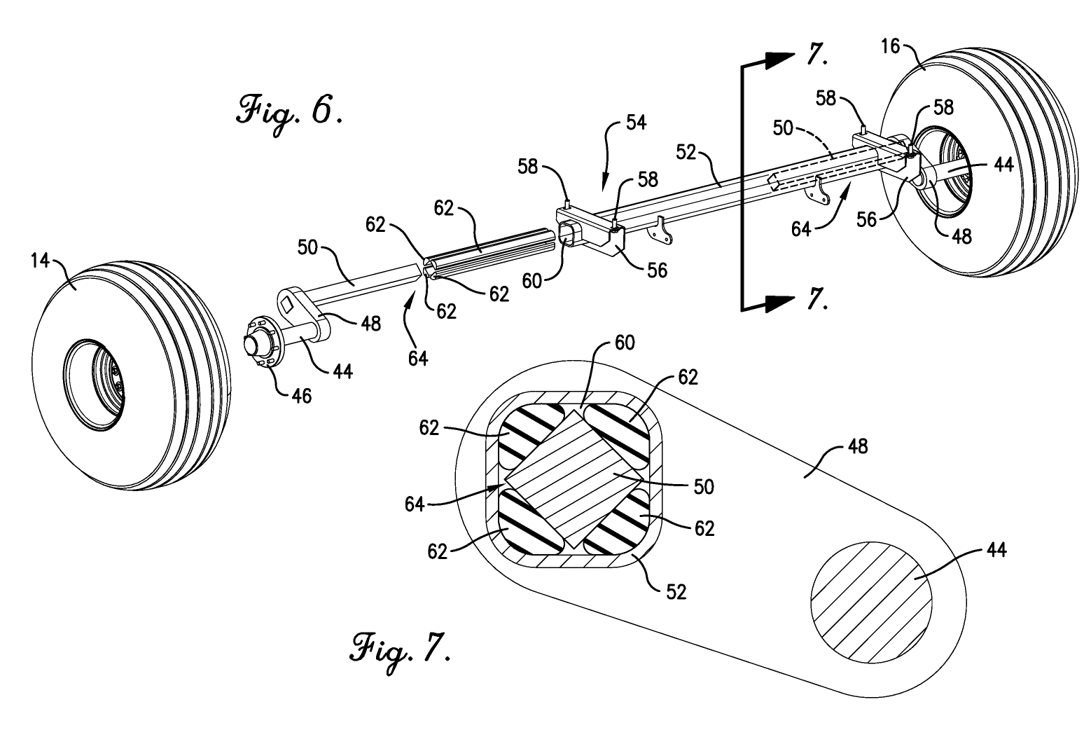

In accordance with the present invention, wheel axes 40 are defined by a pair of relatively short spindles 44 that project laterally outwardly from opposite sides of the baler. Each spindle 44 rotatably supports a hub 46 at its outer end that is bolted to the corresponding wheel 14, 16. At their inner ends, each spindle 44 is fixed to a forwardly extending wheel arm 48 located outboard of respective side panels 20 and 22. At their forward ends, wheel arms 48 are fixed to a pair of inwardly extending, square shafts 50 (FIG. 6) that are rotatably received within the opposite ends of a tubular square axle 52.

Axle 52, shafts 50, wheel arms 48, spindles 44 and hubs 46 all comprise components of a suspension axle assembly broadly denoted by the numeral 54. Suspension axle assembly 54 is rigidly affixed to chassis 12 via a pair of mounting brackets 56 fixed to axle 52 adjacent opposite ends thereof. Each bracket 56 is bolted to the underside of chassis 12 using a pair of bolt assemblies 58.

The tubular nature of axle 52 results in the sidewalls of axle 52 defining an internal chamber 60. Although chamber 60 is the same square shape as shafts 50, it is approximately one-third larger than shafts 50 such that there is space surrounding shafts 50 within chamber 60. This space is, for the most part, occupied by resilient cushion structure in the nature of four resilient pads 62 for each shaft 50. Pads 62 comprise a further part of suspension axle assembly 54 and are arranged between external surfaces of each shaft 50 and proximal internal surfaces of the sidewalls that define chamber 60.

FIG. 7 illustrates one of the wheel arms 48 in an essentially no-load situation in which pads 62 are yieldably retaining shaft 50 against rotation relative to axle 52 but are not exerting significant resistive rotational force. In this no-load position, shaft 50 is rotatively indexed approximately 45° degrees from axle 52 such that the broad, flat surfaces of shaft 50 are facing respective internal comers of chamber 60. Pads 62 are generally triangular in transverse cross-sectional configuration and have their apexes matingly received within the comers of chamber 60 with their broad bases engaging the flat surfaces of shaft 50. In this no-load position of FIG. 7, wheels 14, 16 are in their lowermost position relative to axle 52.

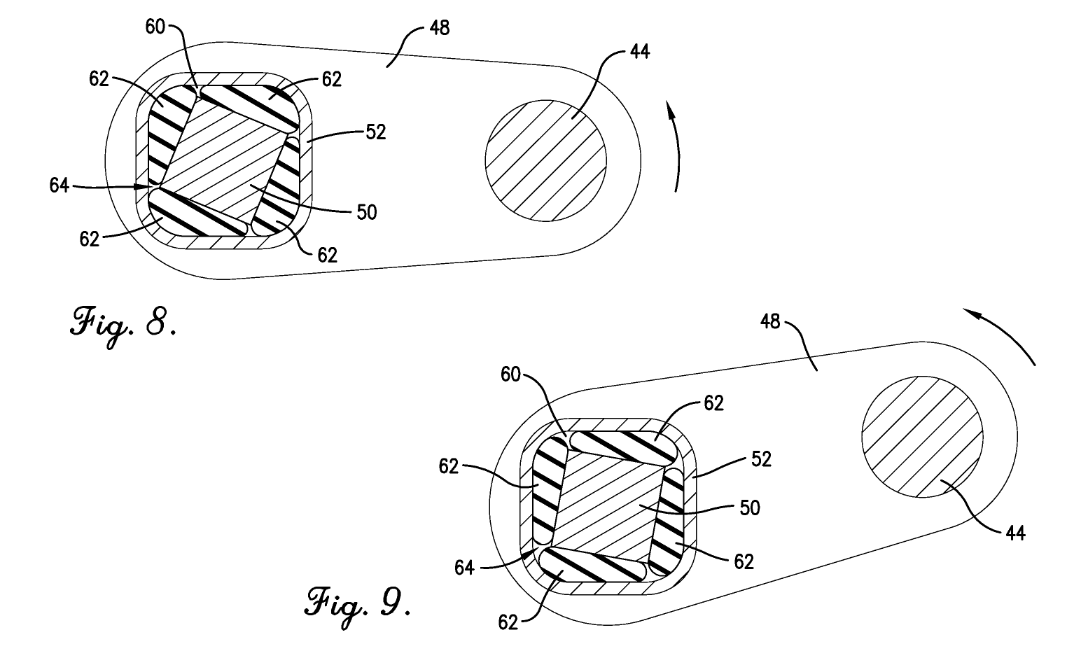

FIG. 8 shows wheel arm 48 raised to a nominal, load-bearing position rotated counterclockwise from its lowermost FIG. 7 position. Shaft 50 is correspondingly rotated counterclockwise within axle 52, causing pads 62 to be compressed and flattened out as the flat external surfaces of shaft 50 move toward a parallel relationship with the flat internal surfaces of chamber 60. Pads 62 yieldably resist rotation of shaft 50 in the counterclockwise direction corresponding to upward swinging of wheel arm 48.

FIG. 9 illustrates wheel arm 48 in its uppermost position corresponding to the highest position of wheels 14, 16 relative to axle 52. In this position pads 62 are in their most compressed state and are exerting their maximum resistive force against counterclockwise rotation of wheel arm 48. This position corresponds to a shock load position such as occurring when the wheel associated with arm 48 encounters a sudden impact load from the ground or roadway. In stable, flat and relatively smooth conditions when the baler is fully loaded with a full size bale, it is contemplated that wheel arms 48 will be in their essentially horizontal, nominal load positions of FIG. 8.

It is to be noted that the two shafts 50 are not connected to one another at their inboard ends. Thus, each shaft 50 is free to rotate independently of the other within axle 52. This provides each of the wheels 14, 16 with an independent suspension, allowing each to react as needed to abrupt terrain changes that might be encountered by that particular wheel.

It is also to be noted that axle 52 is offset a substantial distance forwardly of the wheel spindles 44. Thus, the region under and across bale chamber 28 between wheel spindles 44 is open and unobstructed. As bale 30 exits the baler as shown in FIG. 5, the absence of axle 52 between spindles 44 enables bale 30 to drop to the ground rather than being caught by axle 52. While the exiting bale 30 typically engages axle 52 as the bale leaves chamber 28, its rolling motion and downward momentum is enough to carry it on past axle 52 and onto the ground without stopping. Thereupon, kicker 34 may be actuated to roll bale 30 rearwardly a sufficient distance that tailgate 32 can be closed.

It has been found that one suitable axle assembly for serving as axle assembly 54 of the present invention is available from Off Highway Systems, Henschen Products Group of Jackson Center, Ohio. This axle assembly is marketed by such company under the trademark and name “Dura-Flex” Rubber Torsion Axle.

It should be apparent from the foregoing that shafts 50 and pads 62 collectively comprise suspension apparatus 64 that is operably interposed between axle 52 and pivotal arms 48. A baler 10 constructed in accordance with the present invention is thus provided with a suspension system that gently cushions the ride of the baler and eliminates damaging shock loads that would otherwise jar both the machine and the operator. As the baler 10 is towed across the field or along the road, wheels 14, 16 simply yield upwardly as needed under the cushioning resistance of the pads 62 to absorb bumps and other abrupt terrain changes to smooth out the ride. Having each wheel 14, 16 independently suspended permits each wheel to accommodate its own individual shock loads without affecting the other wheel, thus providing a steadier, more level ride for the baler than might otherwise be the case. Furthermore, all of these benefits are achieved without impeding the discharge of a finished bale from the bale chamber when the baling cycle has been completed.

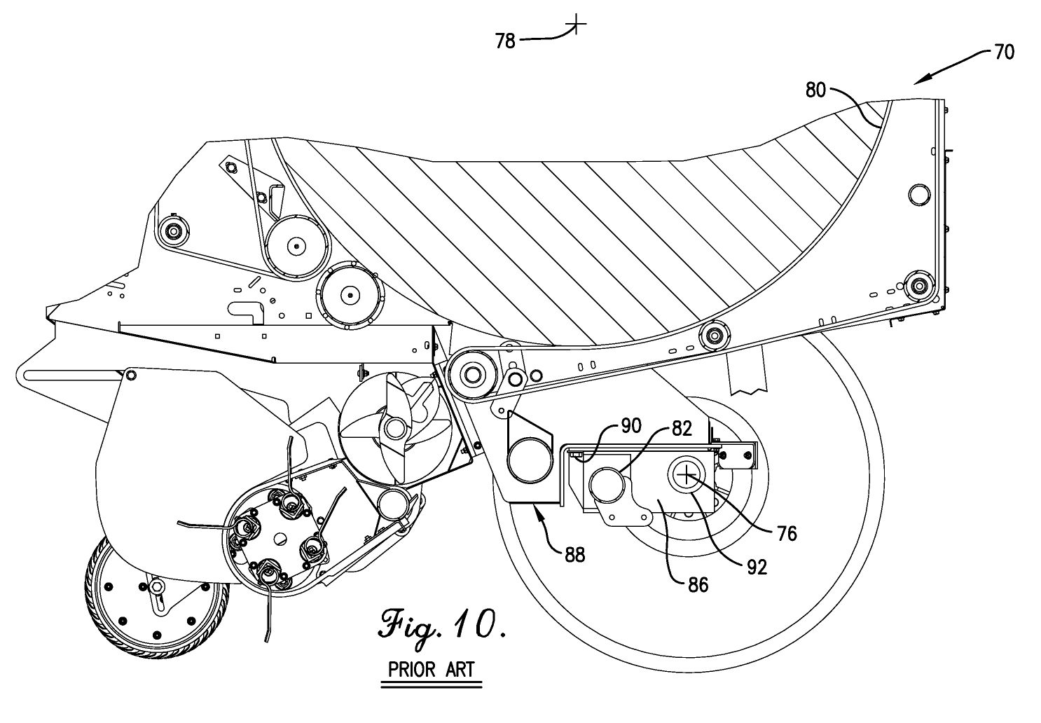

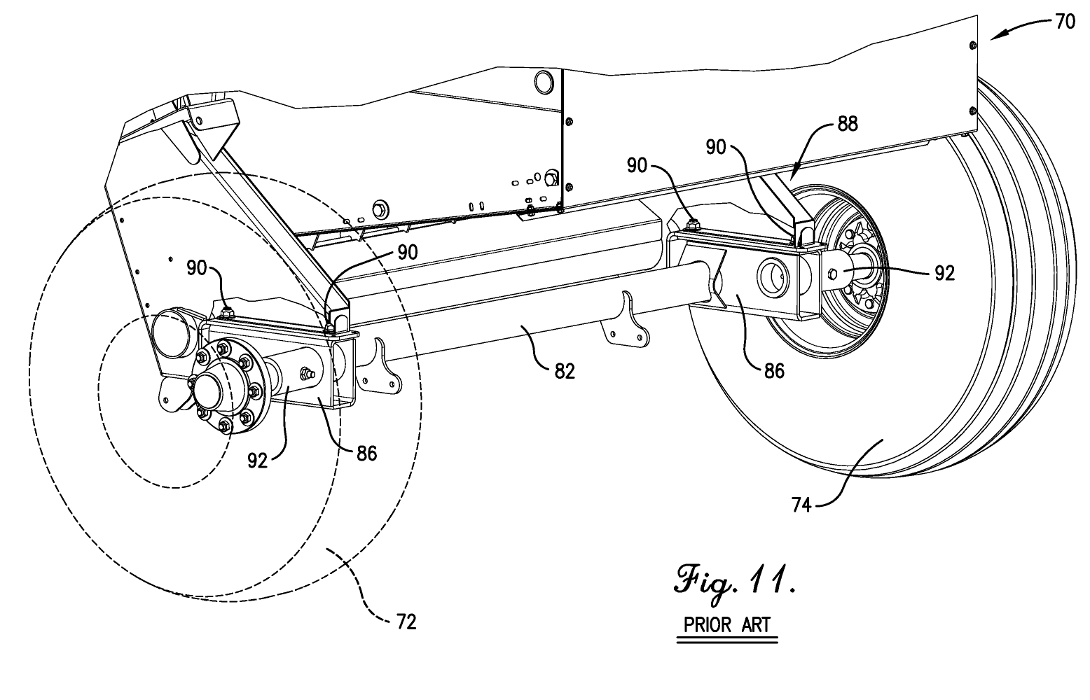

### Prior Art Baler of FIGS. 10 and 11

The prior art baler 70 in FIGS. 10 and 11 has no suspension system. Its ground wheels 72, 74 have their axes of rotation 76 disposed in axial alignment with one another below and behind the fore-and-aft center 78 of baling chamber 80. A transversely circular, fixed axle 82 spans baling chamber 80 below the same and is rigidly affixed at its opposite ends to a pair of fore-and-aft beams 86. Beams 84, 86 are secured to chassis 88 of baler 70 by bolts 90.

Wheel axes 76 are defined by a pair of spindles 92 disposed at the rear ends of beams 86 and projecting laterally outwardly therefrom. Axle 82 is thus offset forwardly from spindles 92 so as to clear out the area between spindles 92 and prevent interference with a discharging bale from chamber 80.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. A round baler comprising:
a rear tailgate that can be raised to open an internal baling chamber for the purpose of ejecting a bale onto the ground from the chamber;
a pair of ground-engaging support wheels on opposite sides of the baler that are rotatable about a pair of axes of rotation disposed rearwardly of the fore-and-aft center of the chamber when the chamber is full-size;
a pair of spindles rotatably supporting respective ones of said wheels and defining said axes of rotation;
a fixed transverse axle spanning said baling chamber below the same in parallel relationship with said spindles,
said axle being offset forwardly from said spindles to provide clearance for the bale as it exits from the chamber when the tailgate is raised;
a pair of arms having rear ends affixed to inner ends of said spindles and forward ends pivotally coupled with said axle in a manner to permit the arms and wheels to swing up and down about the longitudinal axis of the axle; and
suspension apparatus interposed between the axle and the arms to cushion the baler as it transverses uneven terrain.

2. A round baler as claimed in claim 1,
said axle being tubular,
said suspension apparatus including a pair of shafts fixed to said forward ends of the arms and rotatably received within opposite ends of the axle,
said suspension apparatus further including cushion structure within the axle yieldably resisting rotation of the shafts in a direction corresponding to upward swinging of the arms and the wheels.

3. A round baler as claimed in claim 2,
said axle presenting for each of said shafts an internal chamber that is rectangular in transverse cross-sectional configuration,
each of said shafts having a rectangular transverse cross-sectional configuration of reduced dimensions relative to said chamber,
said cushion structure comprising a plurality of resilient pads interposed between external surfaces of said shaft and internal surfaces of said chamber.

4. A round baler as claimed in claim 3,
said shafts being disconnected from one another to provide independent suspension of the wheels relative to one another.

5. A round baler as claimed in claim 1,
said arms being pivotally coupled with the axle independently of one another to provide independent suspension of the wheels relative to one another.
